(19) United States
(12) Patent Application Publication
(10) Pub. No.: US 2012/0006800 A1
(43) Pub. Date: Jan. 12, 2012

(54) WELD BEAD FEATURE COMMUNICATION SYSTEMS AND DEVICES

(75) Inventors: Joseph Robert Ryan, Greenville, WI (US); Indra Budiman Wiryadinata, Appleton, WI (US); Jeffrey Dale Johnson, Appleton, WI (US); Joseph C. Schneider, Menasha, WI (US)

(73) Assignee: Illinois Tool Works Inc., Glenview, IL (US)

(21) Appl. No.: 13/177,478

(22) Filed: Jul. 6, 2011

Related U.S. Application Data
(60) Provisional application No. 61/363,038, filed on Jul. 9, 2010.

(51) Int. Cl. B23K 9/10

(52) U.S. Cl. 219/130.21

(57) ABSTRACT

A welding system including an operator interface having a weld bead feature indicator and a weld parameter adjustment selector is provided. The weld parameter adjustment selector is adapted to receive a desired weld parameter adjustment from an operator. The welding system also includes control circuitry communicatively coupled to the operator interface and adapted to receive data encoding the desired weld parameter adjustment, to determine a change in a weld bead feature corresponding to the desired weld parameter adjustment, and to control the visual weld bead feature indicator to visually communicate the change in the weld bead feature to the operator.

### CROSS REFERENCE TO RELATED APPLICATIONS

This application is a Non-Provisional patent application of U.S. Provisional Patent Application No. 61/363,038 entitled “Intuitive Real Time Dynamic Weld Profile Characteristic Display”, filed Jul. 9, 2010, which is herein incorporated by reference.

### BACKGROUND

The invention relates generally to welding systems and, more particularly, to visual weld bead feature indicators capable of indicating a change in a weld bead feature value to a welding operator.

Welding is a process that has become ubiquitous in various industries for a variety of types of applications. For example, welding is often performed in applications such as shipbuilding, industrial construction and repair, and so forth. During such welding processes, a variety of control devices are often provided to enable an operator to control one or more parameters of the welding operation. For example, foot and hand activated controls capable of functioning as user interfaces may be provided to enable the operator to alter the amperage, voltage, or any other desirable parameter of the welding process. Traditionally, when an operator is attempting to optimize features of the weld bead profile, the operator alters one or more weld parameters through a suitable interface and observes the effect on the weld bead profile. Accordingly, inexperienced welding operators may require substantial amounts of time and/or materials while attempting to achieve the desired weld bead profile. Furthermore, this trial and error process may reduce the overall efficiency of the welding process because a significant amount of operator time is spent altering parameters and observing the effects of these alterations. Accordingly, there exists a need for improved welding systems that reduce or eliminate these inefficiencies.

### BRIEF DESCRIPTION

In an embodiment, a welding system includes a welding power source adapted to generate a welding power output for use in a welding operation and an interface disposed on the welding power source. The interface includes a visual weld bead feature indicator adapted to indicate a value of a feature of a weld bead. The interface is adapted to receive a desired weld parameter adjustment from a user. The welding system also includes control circuitry communicatively coupled to the interface and adapted to receive data encoding the desired weld parameter adjustment, to determine a change in a weld bead feature value corresponding to the desired weld parameter adjustment, and to control the visual weld bead feature indicator to visually indicate the change in the weld bead feature value to a user.

In another embodiment, a method includes receiving data encoding a value of a weld parameter adjustment, determining a resulting change to at least one feature of a weld bead corresponding to the received weld parameter adjustment, and displaying a visual representation of the resulting change on an operator interface associated with a welding device.

In another embodiment, a welding system includes an operator interface having a weld bead feature indicator and a weld parameter adjustment selector adapted to receive a desired weld parameter adjustment from an operator. The welding system also includes control circuitry communicatively coupled to the operator interface and adapted to receive data encoding the desired weld parameter adjustment, to determine a change in a weld bead feature corresponding to the desired weld parameter adjustment, and to control the visual weld bead feature indicator to visually communicate the change in the weld bead feature to the operator.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary welding system including a welding power source having a visual weld bead feature indicator;

FIG. 2 is a diagrammatical illustration of certain components that may be included in the welding system of FIG. 1;

FIG. 3 is a flow chart illustrating exemplary control logic that may be employed by a welding controller to communicate a weld bead feature change corresponding to a parameter adjustment to a user;

FIG. 4 is a flow chart illustrating exemplary logic that may be utilized by a welding controller to communicate changes in weld bead width and weld bead penetration corresponding to a parameter adjustment to a user;

FIG. 5 is a flow chart illustrating exemplary logic that may be utilized by a welding controller to utilize a look-up table to identify a weld bead feature change corresponding to a parameter adjustment;

FIG. 6 illustrates an exemplary embodiment of an operator interface having a visual weld bead feature indicator disposed thereon; and

FIG. 6A is a diagrammatical illustration of an exemplary embodiment of a weld bead feature indicator that may be disposed on the operator interface of FIG. 6.

### DETAILED DESCRIPTION

As described in detail below, provided herein are embodiments of welding systems including weld bead feature indicators capable of indicating a change in a weld bead feature value corresponding to a parameter adjustment. Certain embodiments may position the weld bead feature indicator on a user interface for visual display of the weld bead feature change to a user. For example, in some embodiments, the user may indicate a desired change to a weld parameter (e.g., number of pulses per second, background amperage, peak time, etc.) of a weld profile, and the visual weld indicator may visually indicate which changes in a weld bead feature (e.g., weld bead width, weld bead penetration, etc.) corresponding to the desired weld parameter change. Embodiments of presently disclosed systems may perform one or more operations or calculations to determine the changes corresponding to the weld parameter adjustments. Further, the desired weld parameter changes may be changes the user desires to be made during a welding operation or may be simulated changes indicated by the operator, for example, during a training mode of operation. The foregoing features may reduce or eliminate the amount of time and materials necessary for the user to determine which parameter adjustments are needed to achieve a desired set of weld bead features because the effects of the parameter adjustments are visually communicated to the user via the weld bead feature indicators.

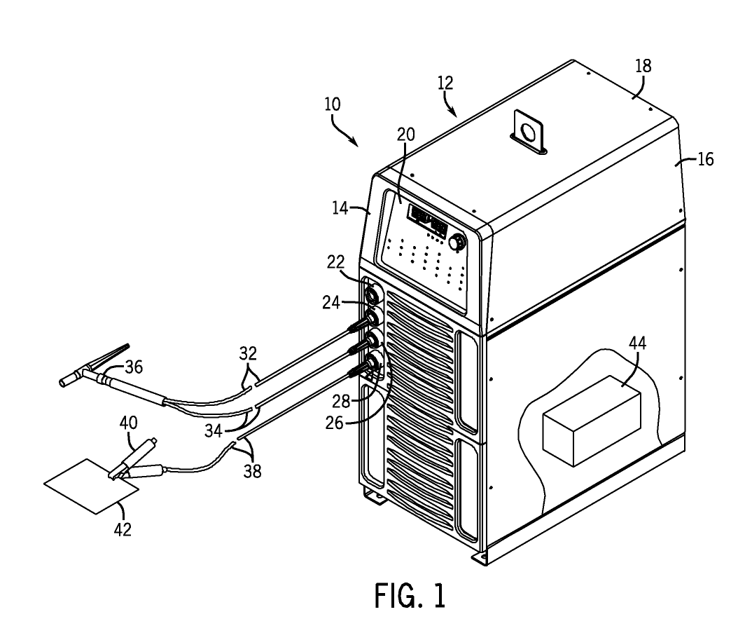

Turning now to the drawings, FIG. 1 is a perspective view of an exemplary welding system 10 including an exemplary welding power source 12 configured to provide a power output for a tungsten inert gas (TIG) welding operation (e.g., a pulsed TIG operation, an alternating current (AC) TIG operation, etc.) or a stick welding operation. However, it should be noted that in further embodiments, the welding power source may be configured to produce power for any desirable type of welding operation (e.g., metal inert gas (MIG) welding). Still further, the weld parameters for which a user may indicate a desired adjustment may be determined by the type of welding operation that the welding power source 12 is adapted to support. For example, if the supported welding operation is a pulsed TIG operation, the weld parameters may be pulse frequency, peak time, and/or background amperage, whereas if the supported welding operation is an AC TIG operation, the weld parameters may be AC frequency or AC balance.

In the illustrated embodiment, the welding power source 12 includes a front panel 14, a side panel 16, and a top panel 18. The front panel 14 includes a control panel 20, through which an operator may control one or more parameters of the welding operation. For example, the user may utilize the control panel 20 to input the desired weld parameter adjustments. In other embodiments, however, the user may utilize other devices, such as a handheld computer or other wireless device, to input the desired weld parameter adjustments. For further example, in embodiments in which the desired weld parameter adjustments are simulated adjustments indicated by a user in a training mode, the control panel 20 may be configured to function independent of the power supply circuitry (i.e., to function without controlling the power source to produce an output for a physical weld operation). Still further, the control panel 20 may include the weld bead feature indicator and, accordingly, may be capable of visually communicating changes to weld bead feature values to the user. In other embodiments, however, the weld bead feature indicator may be located on another control panel or device (e.g., on an interface associated with a weld simulation system).

The welding power source 12 further includes receptacles 22, 24, 26, and 28 that are configured to receive one or more welding devices and/or accessories. For example, in the illustrated embodiment, the first receptacle 22 is a 14-pin connection configured to receive a suitable auxiliary device, the second and third receptacles 24 and 26 receive cables 32 and 34 that connect to a TIG welding torch 36 configured to be utilized in a welding operation to establish a welding arc, and the fourth receptacle 28 receives cable 38 that terminates in ground clamp 40. The ground clamp 40 connects to a workpiece 42 to close the circuit between the welding power source 12, the workpiece 42, and the welding torch 36 during a welding operation. During such an operation, the welding power source 12 is configured to receive primary power from a primary power supply (e.g., a wall outlet, a main power grid, etc.), to condition this incoming power, and to output a weld power output appropriate for use in the welding operation.

The side panel 16 includes a breakaway view illustrating a controller 44 configured to control operation of the welding power source 12. For example, the controller 44 may communicate with the control panel 20 to receive desired weld parameter adjustments, determine a change in a weld bead feature value corresponding to the received parameter adjustments, and control the control panel to display a visual representation of the resulting change. These and other modes of operation of the controller are discussed in more detail below. Additionally, the controller 44 may communicate with power conversion circuitry disposed within the power supply 12 to condition incoming power to generate a weld power output suitable for use in a welding operation.

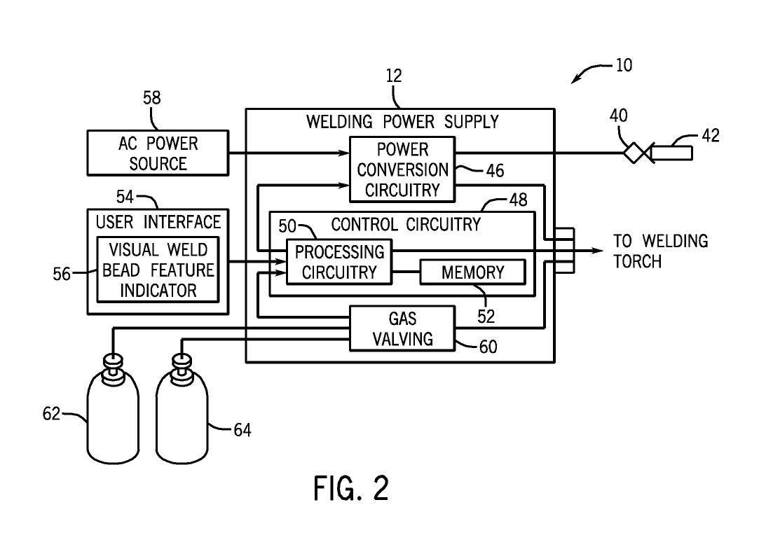

FIG. 2 is a block diagram illustrating components of the welding system 10 of FIG. 1. In the illustrated embodiment, the welding power supply 12 includes power conversion circuitry 46 and control circuitry 48. The control circuitry 48 includes processing circuitry 50 and associated memory 52. During operation, the control circuitry 48 operates to control generation of welding power output for carrying out the desired welding operation. To that end, the control circuitry 48 is coupled to the power conversion circuitry 46. The power conversion circuitry 46 is adapted to create the output weld power, which may be applied, for example, to a welding wire at the welding torch in MIG welding operations. Various power conversion circuits may be employed, including choppers, boost circuitry, buck circuitry, inverters, converters, and so forth. The configuration of such circuitry may be of types generally known in the art. The power conversion circuitry 46 is coupled to a source of electrical power, for example, AC power source 58. The power applied to the power conversion circuitry 46 may originate in the power grid, although other sources of power may also be used, such as power generated by an engine-driven generator, batteries, fuel cells or other alternative sources.

As illustrated, the processing circuitry 50 interfaces with a user interface 54 that allows for data settings, such as desired weld parameter adjustments, to be selected by the operator. The user interface 54 may allow for selection of settings such as the weld process, the type of wire to be used, voltage and current settings, and so forth. Further, the user interface 54 may provide the user with information regarding a welding operation or a simulated welding operation. To that end, the illustrated user interface 54 includes a visual weld bead feature indicator 56 capable of visually communicating a value of a weld bead feature to the user. In particular embodiments, the weld bead feature indicator 56 may be capable of communicating weld bead width and penetration changes corresponding to indicated parameter adjustments to a user.

In certain operational embodiments, the user interface 54 may also allow the operator to choose a type of gas desired for the given application or the processing circuitry 50 may determine an appropriate gas type based on one or more operator selections. To that end, the control circuitry 48 is also coupled to gas control valving 60, which regulates the flow of shielding gas to the welding torch in accordance with the selections chosen by the operator. For example, the gas control valving 60 may selectively regulate the flow of shielding gas from gas cyclinder 62 and gas cylinder 64 in accordance with operator selections. In general, this gas is provided at the time of welding and may be turned on immediately preceding the weld and for a short time following the weld.

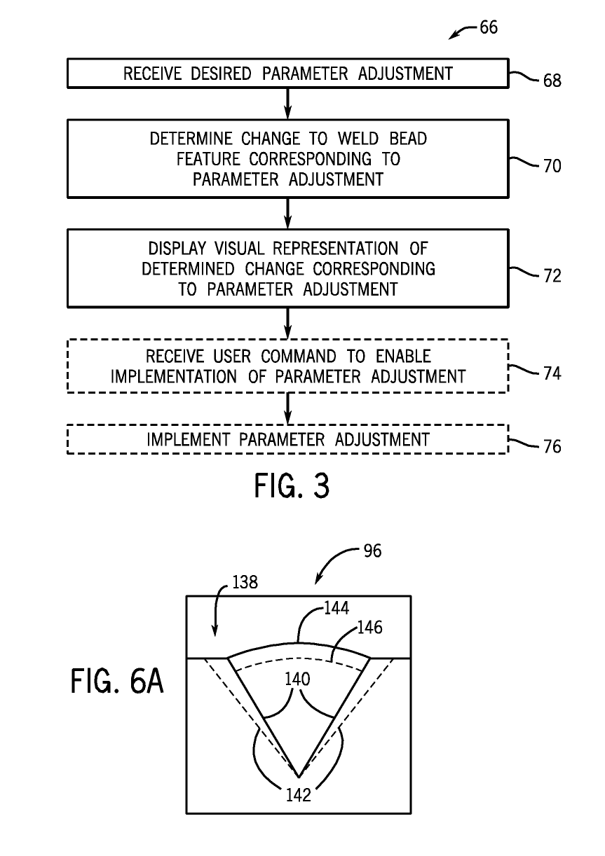

FIG. 3 is a flow chart illustrating a method 66 that may be employed by the welding controller to determine and indicate a weld bead feature change corresponding to a parameter adjustment in accordance with an embodiment. The illustrated method 66 includes receiving a desired parameter adjustment (block 68). For example, the controller may receive an adjustment to a value of a pulser parameter, such as a pulse frequency, a peak time, or a background amperage, which is utilized to control a pulsed TIG welding operation. For further example, the controller may receive an adjustment to a value of an AC TIG welding parameter, such as AC frequency or AC balance. Indeed, the desired parameter adjustment may be an adjustment to any suitable weld parameter for any type of welding operation.

Further, the method 66 includes determining a change to a weld bead feature that corresponds to the parameter adjustment (block 70). For example, the controller may utilize the current settings for a variety of weld parameters in combination with the desired adjustment to calculate a change to a weld bead feature, such as a weld bead width, resulting from the desired adjustment. Once determined, the controller displays a visual representation of the change corresponding to the adjustment (block 72). For example, the controller may communicate the change to a user via an interface disposed, for example, on a welding power supply, a welding simulation device, a handheld device, and so forth.

Further, in some embodiments, once the change has been determined and communicated to the user, the controller may prompt the user for further instructions. In one embodiment, the desired parameter adjustment may not be implemented upon receiving the desired adjustment from the user. Instead, the controller may determine and communicate the weld bead feature changes to the user before prompting the user to determine if the parameter adjustment should be implemented. In these embodiments, the controller may further receive a user command to enable implementation of the parameter adjustment (block 74) and, accordingly, may implement the parameter adjustment (block 76).

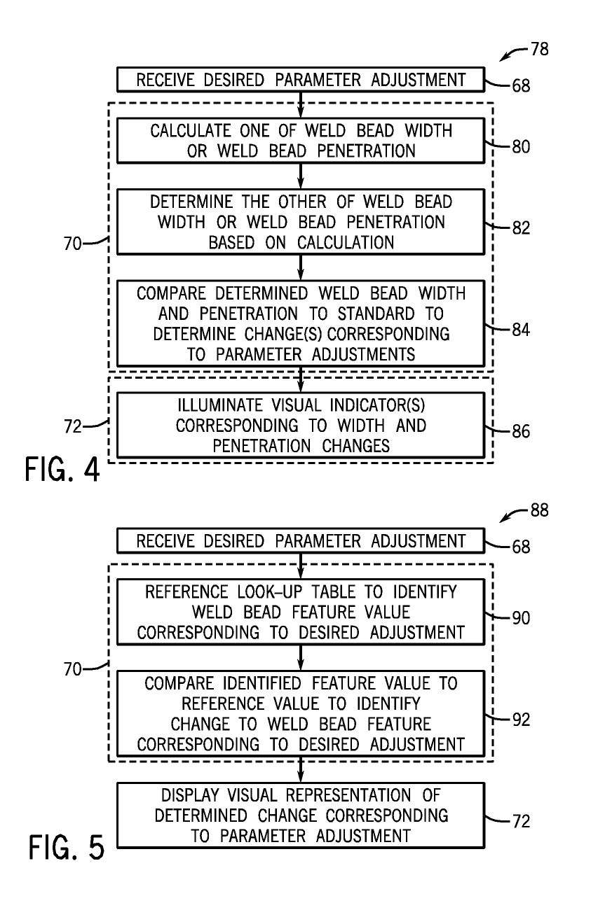

FIG. 4 is a flow chart illustrating a method 78 that is a particular embodiment of the control method 66 of FIG. 3. As before, the method 78 includes receiving the desired parameter adjustment (block 68). However, in this embodiment, various steps are utilized to determine the weld bead feature change corresponding to the parameter adjustment in block 70. Specifically, in this embodiment, the change determination step includes calculating one of weld bead width or weld bead penetration (block 80) and determining the other based on the calculation (block 82). For example, in one embodiment, the adjusted parameter may be pulse frequency, and the controller may calculate the bead width by multiplying the adjusted pulse frequency by an appropriate constant and summing this quantity with the peak time multiplied by an appropriate constant and the background amperage multiplied by an appropriate constant. In this embodiment, once the weld bead width is calculated, the controller may determine the weld bead penetration by inversely relating the calculated weld bead width to the weld penetration.

Similarly, in embodiments in which the welding operation is not a pulsed TIG welding operation, the appropriate weld parameters for the type of operation may be utilized in a similar manner. For example, the parameters of an AC TIG welding operation may be utilized to directly calculate a first weld bead feature (e.g., weld bead width) and to infer a second weld bead feature (e.g., weld bead penetration) from the first weld bead feature. Still further, in other embodiments, more than one weld bead feature may be directly calculated independent of the other calculated features. For example, the weld bead width and the weld bead penetration corresponding to the received parameter adjustment may each be independently calculated or otherwise determined.

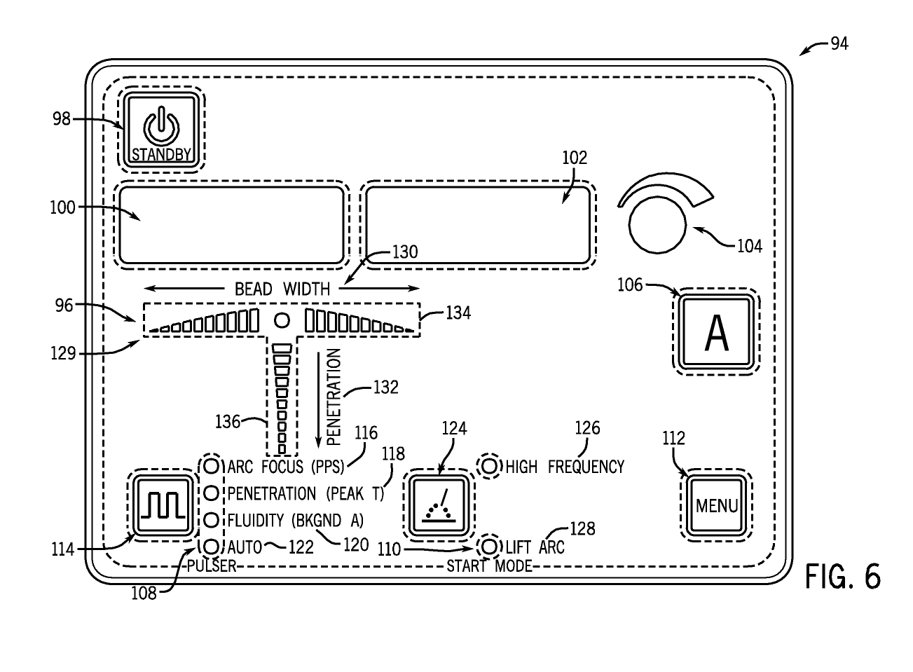

Nevertheless, once the weld bead width and weld bead penetration are determined, the controller implementing the method 78 of FIG. 4 compares the determined values to a reference to determine one or more changes corresponding to the parameter adjustments (block 84). That is, the weld bead width and weld bead penetration may be compared to previous values for these features before the parameter adjustment was made or simulated. The determined changes are then visually represented to the user (block 72), for example, by illuminating visual indicators that correspond to weld bead width and penetration changes (block 86), as discussed in more detail below with respect to FIG. 6. That is, in the illustrated embodiments, the change between the value of the updated weld bead features (e.g., width and penetration) and the previous weld bead features is displayed to the user. It should be noted, however, that in certain embodiments, the calculated values of one or more of the weld bead features may be displayed instead of or in addition to the calculated change if desired by the user.

FIG. 5 is a flow chart illustrating another embodiment of a method 88 that may be employed by the welding controller to determine and display a weld bead feature change corresponding to a parameter adjustment. The method 88 includes receiving the desired parameter adjustment (block 68) and referencing a look-up table to identify a weld bead feature value corresponding to the received adjustment (block 90). That is, the controller may utilize a table of values that indicate an expected change to a weld bead feature based on a combination of a set of weld parameter values. In some embodiments, the look-up table may be determined empirically based on previous welding operations in which observations were made regarding effects of various parameter values on the features of the weld bead. Once the feature value is identified in the look-up table, the controller compares the identified feature value to a reference (e.g., the previous value of the feature before the parameter adjustment) to identify a change to the weld bead feature that corresponds to the desired parameter adjustment (block 92). Finally, a visual representation of the identified change is displayed (block 72).

FIG. 6 illustrates an embodiment of an interface 94 including a weld bead feature indicator 96 capable of indicating a weld bead feature value to a user. The interface 94 also includes a standby indicator 98, a voltage panel 102, an adjustment knob 104, an amperage control button 106, a pulser indication panel 108, a start mode indication panel 110, and a menu selector 112. The illustrated pulser indication panel 108 includes a pulser selector 114, an arc focus indicator 116, a penetration indicator 118, a fluidity indicator 120, and an auto indicator 122. Further, the start mode indication panel 110 includes a process selector 124, a high frequency indicator 126, and a lift arc indicator 128.

During operation, the pulser panel 108 may be utilized to place a welding power supply in a pulsed TIG welding mode of operation and to set parameters of the operation. For example, the user may depress pulser selector 114 to transition between indicator panels 116, 118, 120, and 122 for setting of operational parameter values. For further example, if the user presses pulser selector 114 to activate the fluidity indicator 120, the user may then utilize the knob 104 to specify a desired background amperage level for the pulsed TIG welding operation. For further example, if the user activates the auto indicator 122, the user may set one pulsing parameter, and, based on the user-specified value, the system automatically determines the other parameter values. Similarly, the user may press the process selector 124 to identify which process (e.g., TIG high frequency impulse, TIG lift arc, etc.) is desired for the given application.

In the illustrated embodiment, the weld bead feature indicator 96 is a t-bar shaped indicator 129 including a weld bead width indicator 130 and a weld bead penetration indicator 132. The weld bead width indicator 130 includes a horizontal array 134 of visual indicators (e.g., light emitting diodes (LEDs), backlit panels, etc.), and the weld bead penetration indicator 132 includes a vertical array 136 of visual indicators. During use, the arrays 134 and 136 may be utilized to communicate changes in bead width and bead penetration, respectively, each corresponding to the weld parameter change indicated by the user. For example, in one embodiment, if a desired parameter adjustment received from a user would widen the weld bead width, additional visual indicators in the horizontal array 134 would be activated (e.g., the quantity of activated indicators in the horizontal array may increase from two to four). For further example, in another embodiment, if the desired parameter adjustment would increase weld bead penetration, additional visual indicators in the vertical array 136 would be activated (e.g., the quantity of activated indicators in the vertical array 136 may increase from one to three). Indeed, the quantity of activated visual indicators may be increased or decreased in proportion to the relative expected increase or decrease in the weld bead feature value corresponding to the parameter adjustment. In this manner, the t-bar indicator 129 may be utilized by the weld controller to communicate the changes in a weld bead feature (e.g., weld bead width or penetration) corresponding to the desired parameter adjustment.

Although the weld bead feature indicator 96 is a t-bar indicator 129 in the embodiment of FIG. 6, it should be noted that the indicator 96 may take on a variety of other suitable forms as well. For example, as illustrated in FIG. 6A, the weld bead feature indicator 96 may be a graphical indicator 138 that visually represents a weld bead. In the illustrated embodiment, a change in weld bead width may be indicated to the user by alternating between the narrower lines 140 and the wider lines 142, which correspond to a narrower or wider bead width. In certain embodiments, the lines may have different patterns or colors to indicate the change to the user. Similarly, a change in weld bead penetration may be indicated to the user by alternating between a first line 144 and a second line 146. In this manner, the changes in weld bead width and/or weld bead penetration may be visually communicated to the user.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding system, comprising:
a welding power source configured to generate a welding power output for use in a welding operation;
an interface disposed on the welding power source and comprising a visual weld bead feature indicator configured to indicate a value of a feature of a weld bead, wherein the interface is configured to receive a desired weld parameter adjustment from a user; and
control circuitry communicatively coupled to the interface and configured to receive data encoding the desired weld parameter adjustment, to determine a change in a weld bead feature value corresponding to the desired weld parameter adjustment, and to control the visual weld bead feature indicator to visually indicate the change in the weld bead feature value to a user.

2. The welding system of claim 1, wherein the weld bead feature value comprises a weld bead width, a weld bead penetration, or a combination thereof.

3. The welding system of claim 1, wherein the visual weld bead feature indicator comprises a series of visual indicators configured to be activated in a spatial arrangement corresponding to the change in the weld bead feature value.

4. The welding system of claim 1, wherein the visual weld bead indicator comprises a t-bar spatial arrangement of visual indicators, wherein a horizontal portion of the t-bar comprises visual indicators corresponding to weld bead width and a vertical portion of the t-bar comprises visual indicators corresponding to a weld bead penetration, and wherein the horizontal portion is configured to communicate a change in weld bead width corresponding to the desired weld parameter adjustment and the vertical portion is configured to communicate a change in weld bead penetration corresponding to the desired weld parameter adjustment.

5. The welding system of claim 1, wherein the control circuitry is configured to determine a change in the weld bead feature value by calculating one of weld bead width and weld bead penetration corresponding to the desired weld parameter adjustment and determining the other of weld bead width and weld bead penetration based on the calculation.

6. The welding system of claim 1, wherein the control circuitry is configured to determine a change in the weld bead feature value by comparing the desired weld parameter adjustment to a look-up table.

7. The welding system of claim 1, wherein the visual weld bead feature indicator is configured to communicate the value of the feature of the weld bead by illuminating one or more light emitting diodes (LEDs) in a spatial arrangement in which the position and/or the quantity of the illuminated LEDs corresponds to the value.

8. The welding system of claim 1, wherein the visual weld bead feature indicator comprises numerical indicators configured to communicate the value of the feature of the weld bead.

9. The welding system of claim 1, wherein the visual weld bead feature indicator comprises a screen configured to display the value of the feature of the weld bead.

10. The welding system of claim 1, wherein the desired weld parameter adjustment comprises an adjustment to a pulse frequency, a peak time, a background amperage, an alternating current (AC) frequency, an AC balance, or a combination thereof.

11. A method, comprising:
receiving data encoding a value of a weld parameter adjustment;
determining a resulting change to at least one feature of a weld bead corresponding to the received weld parameter adjustment; and
displaying a visual representation of the resulting change on an operator interface associated with a welding device.

12. The method of claim 11, comprising receiving a user command enabling implementation of the weld parameter adjustment.

13. The method of claim 12, comprising implementing the weld parameter adjustment in a welding operation.

14. The method of claim 11, wherein displaying the visual representation of the resulting change comprises activating a portion of a series of visual indicators corresponding to the value of the resulting change.

15. The method of claim 11, wherein the at least one feature of the weld bead comprises a change in weld bead width, a change in weld bead penetration, or a combination thereof.

16. A welding system comprising:
an operator interface comprising a weld bead feature indicator and a weld parameter adjustment selector configured to receive a desired weld parameter adjustment from an operator; and
control circuitry communicatively coupled to the operator interface and configured to receive data encoding the desired weld parameter adjustment, to determine a change in a weld bead feature corresponding to the desired weld parameter adjustment, and to control the visual weld bead feature indicator to visually indicate the change in the weld bead feature to the operator.

17. The welding system of claim 16, wherein the weld bead feature indicator comprises a first series of visual indicators, each configured to be selectively activated to communicate the change in the weld bead feature to the operator.

18. The welding system of claim 16, wherein the change in the weld bead feature comprises a change in weld bead width, a change in weld bead penetration, or a combination thereof.

19. The welding system of claim 16, wherein the weld parameter adjustment selector comprises a knob, a switch, a graphical user interface, a dial, or a combination thereof.

20. The welding system of claim 16, wherein the desired weld parameter adjustment comprises an adjustment to a pulse frequency, a peak time, a background amperage, an alternating current (AC) frequency, an AC balance, or a combination thereof.
